(19) United States
(12) Patent Application Publication
(10) Pub. No.: US 2015/0222470 A1
(43) Pub. Date: Aug. 6, 2015

(54) Point to Point Split Mount Impairment Correction System

(71) Applicant: Broadcom Corporation, Irvine, CA (US)

(72) Inventor: Igal Yehuda KUSHNIR, Azur (IL)

(73) Assignee: Broadcom Corporation, Irvine, CA (US)

(21) Appl. No.: 14/610,073

(22) Filed: Jan. 30, 2015

Related U.S. Application Data
(60) Provisional application No. 61/934,527, filed on Jan. 31, 2014.

(51) Int. Cl. H04L 27/36; H04W 56/00

(52) U.S. Cl. CPC H04L 27/364; H04W 56/0035; H04L 27/367; H04L 27/2039

(57) ABSTRACT

Systems and methods are provided for lowering the cost and power consumption of outdoor units (ODUs) by providing digital corrections of ODU impairments within indoor units (IDUs). For example, in an embodiment, an error correction module located in the IDU can digitally correct the ODU impairments. Embodiments of the present disclosure allow direct transmission and direct reception in ODUs without any image or LO leakage filtering.

### CROSS REFERENCE TO RELATED APPLICATIONS

This application claims the benefit of U.S. Provisional Patent Application No. 61/934,527 filed on Jan. 31, 2014, and is incorporated by reference herein in its entirety.

### FIELD OF THE DISCLOSURE

The disclosure generally relates to microwave systems, including systems for minimizing impairments generated during upconversion and downconversion in microwave systems.

### BACKGROUND

In communication systems, a point to point (PtP) communication link connects a single node to another single node. In contrast, a point to multipoint link connects a single node to multiple nodes. Microwave systems are frequently used for PtP communication. Microwave systems have several advantages over alternative communication systems. For example, microwave systems use high frequencies, which require smaller antennas, and these high frequencies can enable microwave systems to have a high data transmission rate and broad bandwidth.

PtP communications are commonly used between nodes in a backhaul portion of a wireless communication network. The backhaul portion includes links between nodes of the core network. For example, in a wireless PtP communication system, a first antenna can have a PtP communication link to a second antenna. Each antenna can include a dish reflector, a horn and an outdoor unit (ODU). Other types of antennas can be used as will be understood by those skilled in the art.

The ODU typically performs both necessary intermediate frequency (IF) conversions as well as radio frequency (RF) conversions. Therefore, these conventional outdoor units are relatively large in size, and are generally quite complicated to implement within these conventional antennas. Additionally, there is a lack of low cost components in the current marketplace that can perform the necessary RF conversions. Consequently, in addition to their complexity, typical outdoor units are also very expensive.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 illustrates a block diagram of an split mount indoor-outdoor microwave transceiver system according to an embodiment of the present disclosure;

FIG. 2A is a block diagram illustrating the flow of data in an indoor-outdoor microwave transceiver system and I/Q mismatch estimation and correction in an IDU according to an embodiment of the present disclosure;

FIG. 2B is a block diagram illustrating sources of I/Q errors in an indoor-outdoor microwave transceiver system according to an exemplary embodiment of the present disclosure;

FIG. 3A is a block diagram of a PtP system implementing impairment correction for an ODU using an IDU in accordance with an exemplary embodiment of the present disclosure;

FIGS. 3B and 3C are diagrams illustrating how errors in the reference frequency of synthesizers can generate errors at the output frequency of the IF and RF synthesizers;

FIG. 3D shows equations for estimating reference frequencies in accordance with an embodiment of the present disclosure;

FIG. 4 shows diagrams illustrating I/Q impairments in accordance with an embodiment of the present disclosure;

FIG. 5 shows an exemplary estimation and correction system in accordance with an embodiment of the present disclosure; and

FIG. 6 illustrates a flowchart of a method for correcting impairments in indoor units according to an exemplary embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSURE

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of this discussion, the term “module” shall be understood to include one of software, or firmware, or hardware (such as circuits, microchips, processors, or devices, or any combination thereof), or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### 1. OVERVIEW

Embodiments of the present disclosure provide systems and methods for providing digital corrections of outdoor unit (ODU) impairments within indoor units (IDUs). Making these digital corrections in IDUs instead of ODUs advantageously lowers the cost and power consumption of the ODUs. For example, in an embodiment, the IDU can match the frequency of the data transmitted by the ODU to receive data from the ODU containing impairments occurring during transmission of the data. An error correction module located in the IDU can then digitally correct these impairments. In an embodiment, the error correction module compensates for the impairments by cancelling transmission (TX) I/Q errors, rotation errors, and receive (RX) I/Q errors that occurred during transmission.

### 2. POINT TO POINT COMMUNICATION SYSTEMS

Conventional microwave backhaul architectures are generally implemented as either a split mount outdoor unit (split mount ODU) configuration or an all outdoor unit (all ODU) configuration. Conventional split mount ODU configurations are generally comprised of both an indoor unit (IDU) and an outdoor unit (ODU), where the IDU and the ODU are connected over a coaxial interconnect (e.g., a coaxial cable). The IDU in a conventional split mount ODU configuration typically includes a modem, a digital-to-analog converter and a baseband-to-intermediate frequency converter. Under normal operation, these conventional split mount ODU configurations generally involve transmitting an analog signal, at an intermediate frequency, over the coaxial interconnect between the IDU and the ODU.

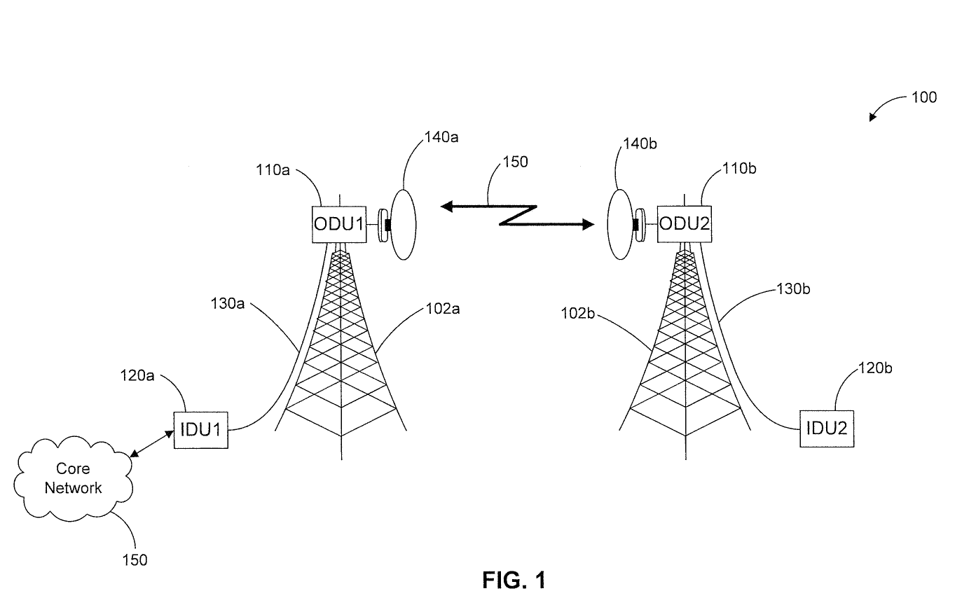

FIG. 1 is a block diagram illustrating a split mount indoor-outdoor microwave transceiver system 100 according to an exemplary embodiment of the present disclosure. In FIG. 1, a first microwave transceiver 102a communicates with a second microwave transceiver 102b by sending data 150 over a wireless microwave communication link in a backhaul portion of a wireless communication network. Each transceiver includes an IDU 120, an ODU 110, and an antenna 140. ODUs 110 communicate with IDUs 120 over communication links 130. In an embodiment, communication links 130 are coaxial cables. Communication links 130 may also include, for example, Ethernet cables, fiber optic cables, twisted pair cables, shielding cables, category 5 cables, category 6 cables, one or more copper wires, or any other cables and/or transmission technology as will be apparent to those skilled in the relevant arts without departing from the spirit and scope of the present disclosure. In some embodiments, communication links 130 can be one or more wireless communication channels configured to utilize one or more well-known wireless communication protocols.

In an embodiment, first microwave transceiver 102a can initiate communication by accessing an information source, which may comprise, for example, audio data, video data, or any other data. To facilitate this communication, IDU1 120a can be electrically connected to a core network 150 via a high-capacity IP/Ethernet connection. In particular, IDU1 120a can be configured to acquire one or more sequences of digital data (e.g., audio data, video data, data transmitted over a high capacity IP/Ethernet connection, or the like) from the core network. IDU1 120a can also be configured to support several additional services, such as Ethernet, and control data that is aggregated over a radio link to provide some examples.

In an embodiment, IDU1 120a may be implemented at a location that is substantially removed from ODU1 110a, such as at a location at ground level. For example, IDU1 120a may be positioned inside of a home or an office building, or the like. Conversely, ODU1 110a may be implemented at a substantially elevated location, such as on top of a pole, on top of an antenna tower, or on top of a building. In some embodiments, IDU1 120a and ODU1 110a may be separated by a distance up to approximately 300 meters. However, the distance of separation is not limited to this exemplary range and can be any distance as will be apparent to those skilled in the relevant arts without departing from the spirit and scope of the present disclosure.

In an embodiment, system 100 can be implemented such that data may be transmitted from IDU1 120a, across communication link 130a, to ODU1 110a, and subsequently to antenna 140a, where communication over a wireless link to second microwave transceiver 102b can then be initiated. System 100 can also be implemented such that data received by antenna 140a (e.g., from second microwave transceiver 102b) can be transmitted from ODU1 110a over communication link 130a to IDU1 120a.

Although FIG. 1 and other exemplary embodiments are described in terms of microwave backhaul architecture, those skilled in the relevant art(s) will recognize that the present disclosure may be applicable to other architectures that use wireless or other wired communication methods without departing from the spirit and scope of the present disclosure.

### 3. DIRECT CONVERSION USING AN ODU

In an embodiment, the link over communication links 130 is a frequency-division duplexing (FDD) link. For example, in the FDD link over communication link 130a, IDU1 120a and ODU1 110a operate at different carrier frequencies. By altering the frequency at which IDU1 120a and ODU1 110a send and receive data, IDU1 120a and ODU1 110a can send and receive a transmission at the same time. Thus, a frequency offset exists between uplink and downlink communications sent between IDU1 120a and ODU1 110a.

In an embodiment, information sent over communication links 130 using FDD contains a transmission (TX) channel, a receive (RX) channel, TX control information, RX control information, and data. For example, in an embodiment, the RX data sent over communication link 130a is an intermediate frequency (IF) signal typically around 140 MHz, and the TX data sent over communication link 130a is an IF signal typically around 350 MHz. At the same time, the frequencies of radio frequency (RF) signals (TX and RX) at ODU1 antenna 140a are at very high frequencies (e.g., typically in the range of 6 GHz to 43.5 GHz).

Due to cost and power savings, implementation of direct conversion receivers and transmitters is desirable, but the implementation is challenging because of the high image rejection and locally controlled oscillator (LO) leakage suppression that is required. For example, in general, the required image rejection and LO leakage suppression are around 80 dB, which is not easily achieved by a straightforward RF design. At the same time, filtering of the LO leakage and/or the image is very challenging and expensive at high RF frequencies.

Direct conversion of the IF signals to the desired TX or RX frequencies is challenging due to the image frequency and LO leakage that might violate the transmission MASK in TX or cause RX desensitization. Therefore, the most common ODU architecture is a superheterodyne transmitter and receiver. The superheterodyne transmitter and receiver filters the image frequency and the LO leakage with external expensive filters (e.g., usually ceramic filters). PtP systems operate at SNR of about 50 dB, so implementation of these up-converters and down-converters (e.g., at 2-3 GHz) would involve power-hungry circuitry and non-trivial silicon size.

### 3.1 Digital Correction of ODU Impairments

In an embodiment, process errors, temperature, and voltage variations in IDUs 120 and ODUs 110 can introduce impairments into transmitted data. In an embodiment, these impairments can be corrected within ODUs 110. However, correcting these impairments within ODUs 110 requires additional functionality within ODUs 110, which increases the cost and power consumption of ODUs 110. Embodiments of the present disclosure provide systems and methods for providing digital corrections of ODU impairments within IDUs 120, which lowers the cost and power consumption of ODUs 110. For example, in an embodiment, an error correction module located in IDUs 120 can digitally correct these impairments.

Embodiments of the present disclosure further enable direct transmission and direct reception in ODUs 110 without any image or LO leakage filtering. For example, in an embodiment, the ODUs 110 can down-convert the signal (e.g., at 350 MHz) coming from the IDUs 120 to baseband. ODUs 110 can then up-convert the IF signal directly to the desired RF frequency (e.g., in the range of 6-43.5 GHz in PtP systems) for transmission by antennas 140. ODUs 110 can also receive RF signals and down-convert them directly to baseband. After filtering interference and stabilizing the power of the received signal (e.g., via an automatic gain controller), the signal is up-converted to low IF frequency (e.g., 140 MHz) and passed to IDUs 120 over communication links 130. In an embodiment, these direct conversions in ODUs 110 generate image frequencies and LO leakage that falls in band, corrupting the signal. Embodiments of the present disclosure provide systems and methods for recovering the signal in IDUs 120 by digital correction (e.g., by cancelling the image and LO leakage).

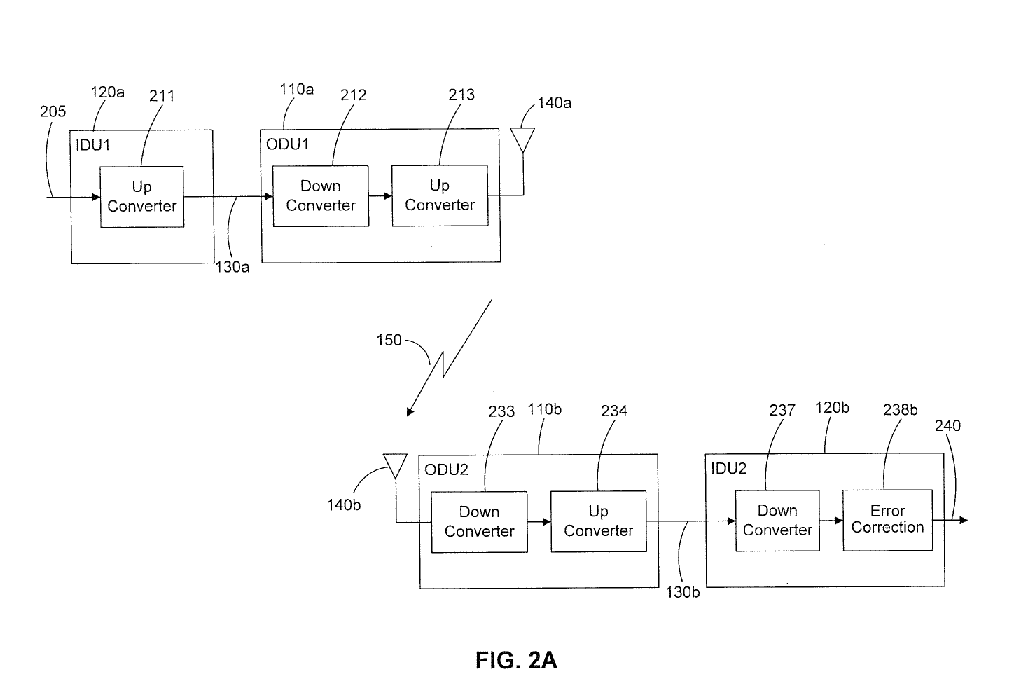

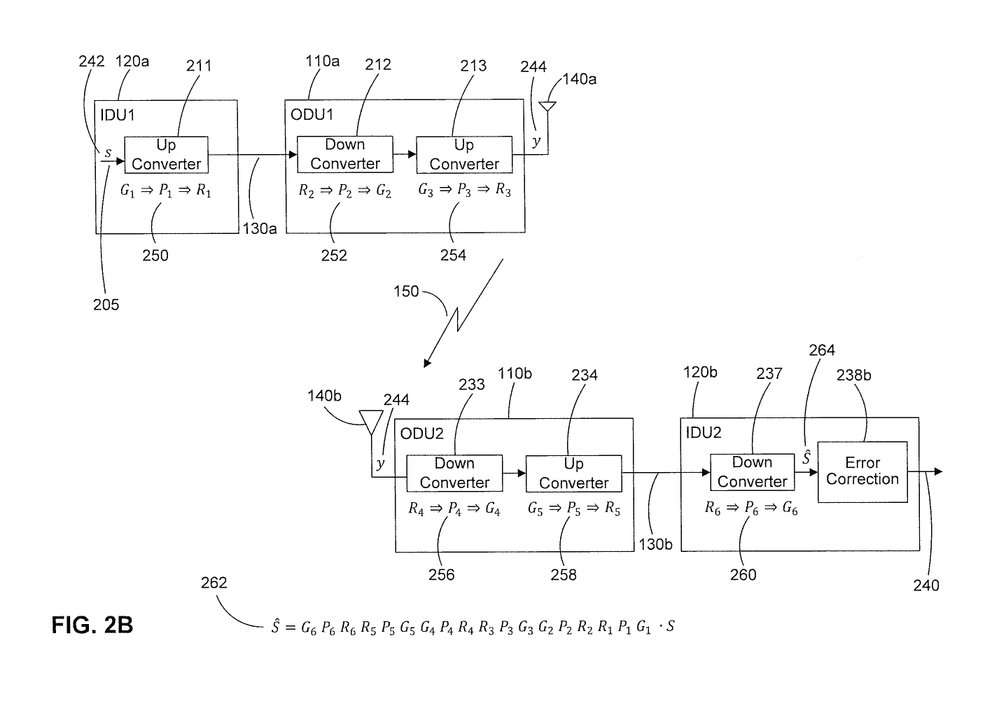

FIG. 2A is a block diagram illustrating the flow of data in an indoor-outdoor microwave transceiver system and I/Q mismatch estimation and correction in an IDU according to an embodiment of the present disclosure. FIG. 2A illustrates data transmission from IDU1 120a to IDU2 120b and the I/Q mismatch estimation and correction performed by error correction module 238b. Error correction module 238b of IDU2 120b compensates for errors that occurred during transmission of the data.

For example, in FIG. 2A, IDU1 120a receives a data signal 205 (e.g., data from a network coupled to system 100) and up-converts data signal 205 into a format usable by ODU1 110a using up-converter 211. For example, in an embodiment, IDU1 120a up-converts data signal 205 from baseband to 350 MHz. IDU1 120a then sends up-converted data signal 205 over communication link 130a (e.g., a coaxial cable) to ODU1 110a. ODU1 110a down-converts data signal 205 to baseband (or to near zero IF frequencies) using down-converter 212. After ODU1 110a performs baseband processing, ODU1 110a up-converts data signal 205 to radio frequency (RF) for transmission using up-converter 213. For example, in an embodiment, ODU1 110a up-converts data signal 205 from baseband to 6-43.5 GHz). ODU1 110a transmits the data over antenna 140a, which sends the data wirelessly to antenna 140b.

Antenna 140b receives data signal 205 and sends it to ODU2 110b. ODU2 110b down-converts data signal 205 from RF to baseband using down-converter 233. After ODU2 110b performs baseband processing, ODU2 110b up-converts data signal 205 using up-converter 234 for transmission to IDU2 120b. For example, in an embodiment, ODU2 110b up-converts data signal 205 from baseband to 140 MHz. ODU2 110b sends the up-converted data signal 205 to IDU2 120b over communication link 130b. IDU2 120b down-converts data signal 205 using down-converter 237. For example, in an embodiment, IDU2 120b down-converts data signal 205 from 140 MHz to baseband. IDU2 120b sends data signal 205 to error correction module 238b to correct errors that occurred during transmission of the data. In an embodiment, error correction module 238b is, or is implemented on, a modem of IDU2 120b. After the errors have been corrected, IDU2 120b can transmit the corrected data 240 to a device and/or network coupled to IDU2 120b. In an embodiment, the various up-converters and down-converters discussed with reference to embodiments of the present disclosure include the requisite mixers, local oscillator, filters, and amplifiers to perform the frequency conversions discussed herein.

### 3.2 Sources of Errors

FIG. 2B is a block diagram illustrating sources of I/Q errors in an indoor-outdoor microwave transceiver system according to an exemplary embodiment of the present disclosure. In FIG. 2, “G” represents gain between I and Q channels. “P” represents phase between I and Q channels. “R” represents rotation (e.g., the frequency error between the desired frequency and the actual frequency). Equation 1 below (labeled 262 in FIG. 2B) shows the different sources of gain, phase, and rotation that can introduce errors into input data signal 205 (e.g., “5”), producing the output signal Ŝ 264.

Ŝ=G₆P₆R₆R₅G₅P₅G₄P₄R₄R₃G₃P₃G₂P₂R₂R₁P₁G₁·S (Equation 1)

As shown in FIG. 2B, because gain, phase, and rotation can vary among IDUs 120 and ODUs 110, there can be many sources of I/Q errors and frequency errors that can occur during transmission of data between IDU1 120a and IDU2 120b. These errors can generate image frequencies that can corrupt the signal. For example, up-converter 211 in IDU1 120a can be associated with a first gain, phase, and rotation 250. Down-converter 212 in ODU1 110a introduces a gain error, phase error, and rotation error 252. Up-converter 213 in ODU1 110a introduces another gain error, phase error, and rotation error 254. ODU1 213 then transmits this up-converted signal y 244 via antenna 140a.

Antenna 140b receives the up-converted signal y 244 and sends it to ODU2 110b. Down-converter 233 in ODU2 110b introduces another gain error, phase error, and rotation error 256. Up-converter 234 in ODU2 110b also introduces a gain error, phase error, and rotation error 258. Down-converter 237 of IDU2 120b can also have a different gain, phase, and rotation 260. Down-converter 237 produces down-converted output signal Ŝ 264. As shown by Equation 1 262, down-converted output signal Ŝ 264 can contain errors from multiple sources, and error correction module 238b can correct these errors before sending the corrected data 240 to a device and/or network coupled to IDU2 120b.

### 3.3 Impairment Correction Using IDUs

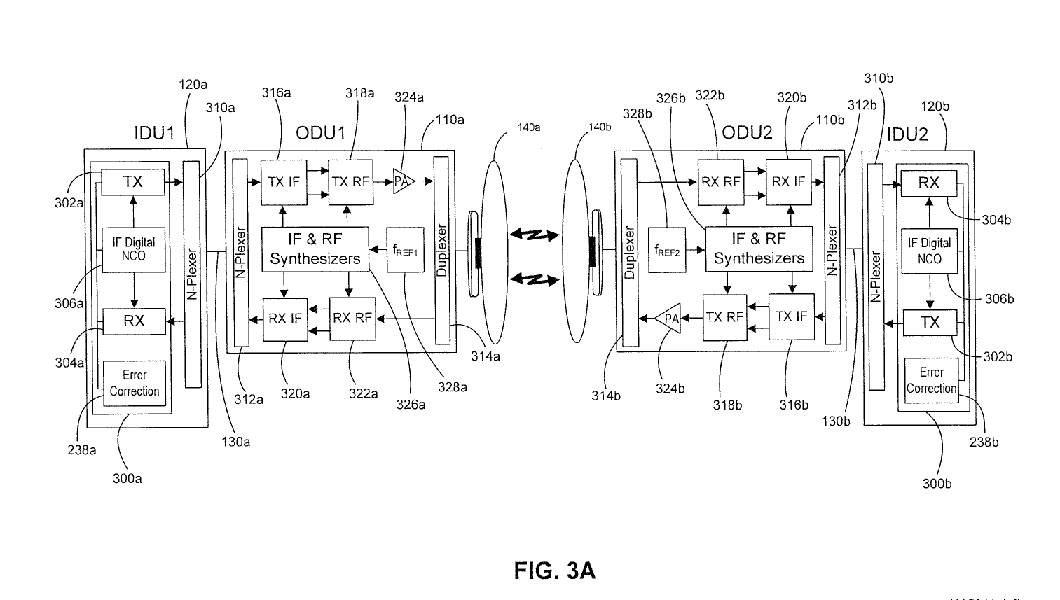

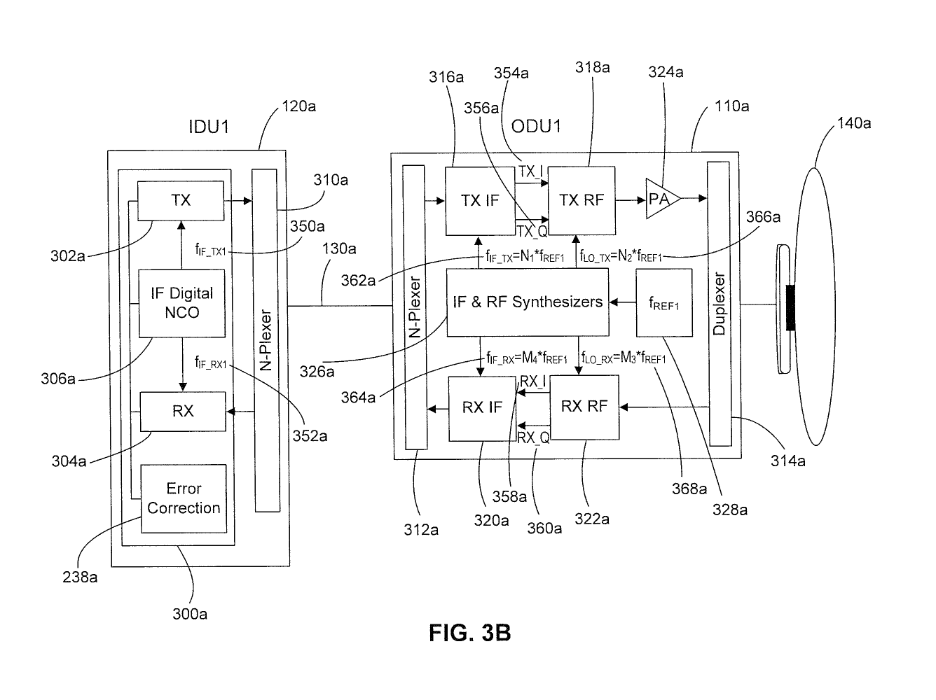

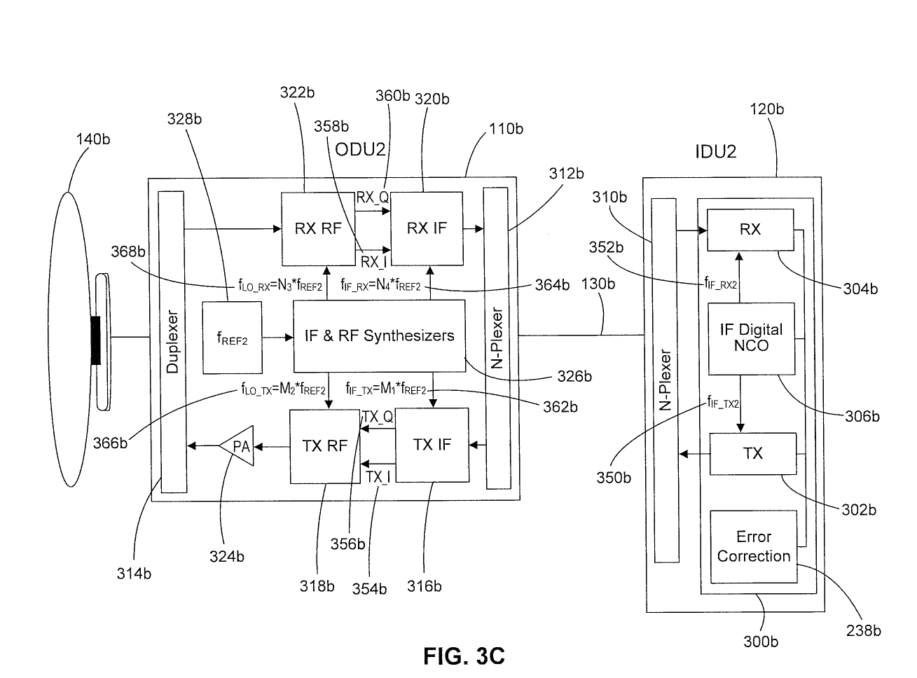

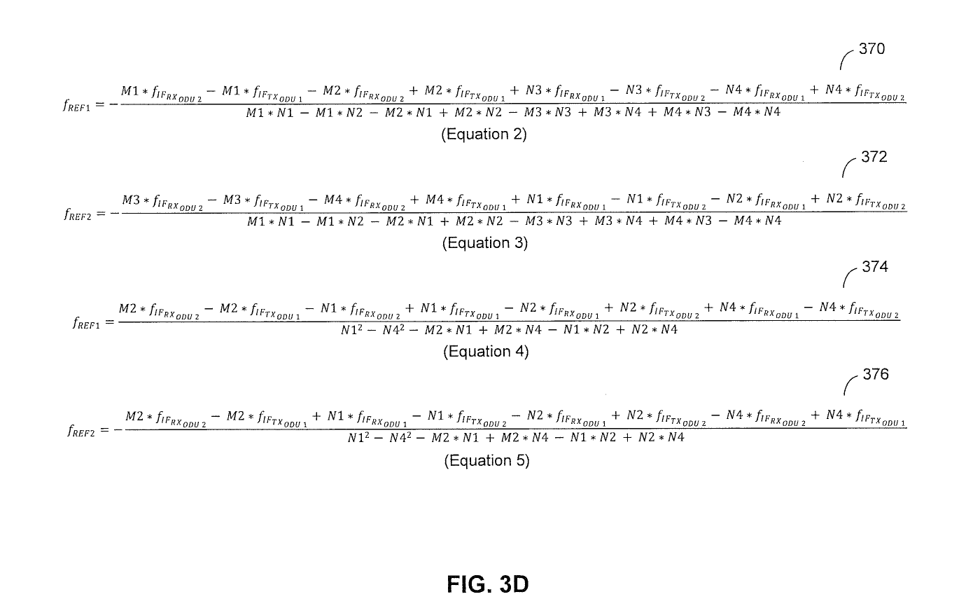

FIG. 3A is a block diagram of a PtP system implementing impairment correction for an ODU using an IDU in accordance with an exemplary embodiment of the present disclosure. In an embodiment, impairment correction for ODUs 110 is performed using error correction modules 238 within devices 300 inside IDUs 120. For example, in an embodiment, devices 300 are modems inside IDUs 120. In an embodiment, devices 300 also include transmit (TX) up-converters 302, receive (RX) down-converters 304, and IF digital numerically controlled oscillators (NCOs) 306. For example, in an embodiment, TX up-converter 302a is substantially identical to up-converter 211 in FIG. 2, and RX down-converter 304b is substantially identical to down-converter 237 in FIG. 2.

In an embodiment, TX up-converter 302a, RX down-converter 304a, IF digital numerically controlled oscillator (NCO) 306a, and error correction module 238a are implemented using a single integrated circuit (IC). In an embodiment, error correction module 238a is implemented on a separate IC. In an embodiment, devices 300 are coupled to N-Plexers 310, which are configured to multiplex and/or demultiplex data. For example, in an embodiment, N-Plexer 310a can multiplex data sent by TX up-converter 302a and/or error correction module 238a and send it to ODU1 110a across communication link 130a. Additionally, in an embodiment, N-Plexer 310a can also demultiplex data sent by ODU1 110a across communication link 130a and send it to RX down-converter 304a.

ODUs 110 are configured to send data that is sent from IDUs 120 across communication links 130 to antennas 140. ODUs 110 are further configured to receive data from antennas 140 and send it to IDUs 120 via communication links 130. ODUs 110 multiplex and/or demultiplex data sent from IDUs 120 via N-Plexers 312. Received data is sent from N-Plexers 312, down-converted using TX intermediate frequency (IF) down-converters 316 to baseband, and processed. Data to be transmitted via antennas 140 is up-converted using TX radio frequency (RF) up-converters 318, amplified by power amplifiers 324, multiplexed using duplexers 314, and sent to antennas 140 for transmission. Received data is multiplexed and/or demultiplexed using duplexers 314, down-converted using RX RF down-converters 322 to baseband, and processed. Data to be sent to IDUs 110 is up-converted using RX IF up-converters 320, multiplexed and/or demultiplexed using N-plexers 312, and sent to IDUs 120 via communication link 130.

In an embodiment, TX IF down-converter 316a is substantially identical to down-converter 212 in FIG. 2. In an embodiment, TX RF up-converter 318a is substantially identical to up-converter 213 in FIG. 2. In an embodiment, RX RF down-converter 322b is substantially identical to down-converter 233 in FIG. 2. In an embodiment, RX IF up-converter 320b is substantially identical to up-converter 234 in FIG. 2.

### 3.4 Local Oscillator Reference Frequency Deviation

In an embodiment, IF and RF synthesizers 326 generate locally controlled oscillator (LO) signals, based on reference frequencies f_{REF1} 328a and f_{REF2} 328b, to be used by TX IF down-converters 316 and by RX RF up-converters 318 and 322. Additionally, IF digital NCOs 306 generate LO signals to be used by TX up-converters 302, RX down-converters 304, and/or error correction modules 238. These reference frequencies can deviate from their desired values due to process errors, temperature, and voltage variations in IDUs 120 and ODUs 110. Any error in the reference frequency f_{REF1} 328a and f_{REF2} 328b of IF and RF synthesizers 326 would likely generate an error at the output frequency of IF and RF synthesizers 326.

FIGS. 3B and 3C illustrate how errors in the reference frequency of IF and RF synthesizers 326 generate errors at the output frequency of IF and RF synthesizers 326. FIG. 3B illustrates errors at the output frequency of IF and RF synthesizer 326a of ODU1 110a. FIG. 3C illustrates errors at the output frequency of IF and RF synthesizer 326b of ODU2 110b. In FIGS. 3B and 3C, the output frequency of IF digital NCOs 306 to TX up-converters 302 is shown as f_{IF}_{_{—}}_{TX1} 350a and f_{IF}_{_{—}}_{TX2} 350b, and the output frequency of IF digital NCOs 306 to RX down-converters 304 is shown as f_{IF}_{_{—}}_{RX1} 352a and f_{IF}_{_{—}}_{RX2} 352b. The output frequency of IF and RF synthesizers 326 to TX IF down-converters 316 is shown as f_{IF}_{_{—}}_{TX} 362. The output frequency of IF and RF synthesizers 326 to TX RF up-converters 318 is shown as f_{LO}_{_{—}}_{TX} 366. The output frequency of IF and RF synthesizers 326 to RX IF up-converters 320 is shown as f_{IF}_{_{—}}_{RX} 364. The output frequency of IF and RF synthesizers 326 to RX RF down-converters 322 is shown as f_{LO}_{_{—}}_{RX} 368.

In an embodiment, direct re-modulation (e.g., up-converting from baseband to RF) and re-demodulation (e.g., down-converting from RF to baseband) have limited I/Q matching. Thus, the transmitted data can be corrupted by the image frequencies. The transmitted data can be recovered using I/Q correction techniques (e.g., as performed by error correction modules 238).

### 3.5 Reference Frequency Derivation

Error correction modules 238 can compensate for I/Q mismatches and recover the transmitted data. In an embodiment, error correction modules 238 recover the transmitted data by estimating f_{REF1} 328a and f_{REF2} 328b, cancelling IF frequency errors, and cancelling I/Q errors.

In an embodiment, desired values of the TX and RX frequencies for IF and RF synthesizers 326 (e.g., f_{IF}_{_{—}}_{TX} 362, f_{LO}_{_{—}}_{TX} 366, f_{IF}_{_{—}}_{RX} 364, and f_{LO}_{_{—}}_{RX} 368) are known (and thus constants N₁, N₂, N₃, N₄, M₁, M₂, M₃, and M₄ shown in FIGS. 3B and 3C are known), and errors in the f_{REF1} 328a and f_{REF2} 328b cause f_{IF}_{_{—}}_{TX} 362, f_{LO}_{_{—}}_{TX} 366, f_{IF}_{_{—}}_{RX} 364, and f_{LO}_{_{—}}_{RX} 368 to deviate from these desired values. For example, in an embodiment, N₁, N₂, N₃, N₄, M₁, M₂, M₃, and M₄ are values that can be configured by the system vendor of ODUs 110.

Error correction modules 238 can estimate f_{REF1} 328a and f_{REF2} 328b and can correct the errors in f_{REF1} and f_{REF2}. As shown in FIGS. 3A and 3B, f_{IF}_{_{—}}_{TX} 362, f_{LO}_{_{—}}_{TX} 366, f_{IF}_{_{—}}_{RX} 364, and f_{LO}_{_{—}}_{RX} 368 are determined by f_{REF1} 328a and f_{REF2} 328b. When, for example, RX IF up-converter 320a mixes f_{IF}_{_{—}}_{RX} 364 with the output of RX RF down-converter 322a to generate an output signal, this output signal deviates from a desired value due to errors in f_{REF1} 328a. Because, for example, error correction module 238a is aware of the desired value for f_{REF1} 328a, error correction module 238a can determine a desired frequency of the signal it receives from RX IF up-converter 320a. Based on the difference between the actual frequency of the signal error correction module 238a receives from RX IF up-converter 320a and the desired frequency of this signal, error correction module 238a can estimate the actual frequency of f_{REF1} 328a.

In an embodiment, the frequency output from RX down-converter 304a is expected to be at baseband, and therefore any offset from baseband of the actual frequency output from RX down-converter 304a can be due to error(s) in f_{REF1} 328a. Error correction module 238a can adjust the frequency of IF digital NCO 306a to compensate for this frequency offset. Specifically, error correction module 238a can adjust the frequency of IF digital NCO 306a so that f_{IF}_{_{—}}_{RX1} 352a matches f_{IF}_{_{—}}_{RX} 364a, so as to adjust the output frequency of RX down-converter 304a to baseband. In another embodiment, the error correction module 238a has knowledge of the output frequency of RX IF up-converter 320a and can make adjustments based on this knowledge. Alternatively, instead of using baseband as a reference for determining frequency offset, a pre-determined low IF can be used as will be understood by those skilled in the arts. Additional error correction in accordance with an embodiment of the present disclosure is explained in greater detail below in Section 3.6.

FIG. 3D shows equations for estimating f_{REF1} 328a and f_{REF2} 328b. Equation (2) 370 shows an equation for estimating values for f_{REF1} 328a, and Equation (3) 372 shows an equation for estimating f_{REF2} 328b. As shown by Equation (2) 370 and Equation (3) 372, f_{REF1} 328a and f_{REF2} 328b can be derived using (1) constants N₁, N₂, N₃, N₄, M₁, M₂, M₃, and M₄, and (2) the frequencies generated by IF digital NCOs 306 of ODUs 120: f_{IF}_{_{—}}_{TX1} 350a, f_{IF}_{_{—}}_{RX1} 352a, f_{IF}_{_{—}}_{TX2} 350b, and f_{IF}_{_{—}}_{RX2} 352b. During communication between IDU1 120a and IDU2 120b, IDU1 120a and IDU2 120b transmit frequencies generated by IF digital NCOs 306 to each other. For example, IDU1 120a has knowledge of f_{IF}_{_{—}}_{TX1} 350a and f_{IF}_{_{—}}_{RX1} 352a because f_{IF}_{_{—}}_{TX1} 350a and f_{IF}_{_{—}}_{RX1} are generated by IF digital NCO 306a.

In an embodiment, IDU1 120a has knowledge of the values of f_{IF}_{_{—}}_{TX2} 350b and f_{IF}_{_{—}}_{RX2} 352b. For example, in an embodiment, IDU1 120a has knowledge of f_{IF}_{_{—}}_{TX2} 350b and f_{IF}_{_{—}}_{RX2} 352b because IDU2 120b transmits f_{IF}_{_{—}}_{TX2} 350b and f_{IF}_{_{—}}_{RX2} 352b to IDU1 120a during communication with IDU1 120a (e.g., via a message from IDU2 120b to IDU1 120a). Alternatively, in an embodiment, IDU1 120a can know the values of f_{IF}_{_{—}}_{TX2} 350b and f_{IF}_{_{—}}_{RX2} 352b because NCOs 306 can be presumed to be accurate (for example, because NCOs 306 are operating in an indoor environment and may be more accurate than non-NCO oscillators). Likewise, in an embodiment, IDU2 120b has knowledge of the values of f_{IF}_{_{—}}_{TX1} 350a and f_{IF}_{_{—}}_{RX1} 352a. Thus, using known values for f_{IF}_{_{—}}_{TX1} 350a, f_{IF}_{_{—}}_{RX1} 352a, f_{IF}_{_{—}}_{TX2} 350b, and f_{IF}_{_{—}}_{RX2} 352b and known constants N₁, N₂, N₃, N₄, M₁, M₂, M₃, and M₄, IDUs 120 can calculate f_{REF1} 328a and f_{REF2} 328b using Equation (2) 370 and Equation (3) 372.

In an embodiment, if ODUs 110 have substantially identical hardware, nominal values of f_{REF1} 328a and f_{REF2} 328b are substantially the same. If f_{REF1}=f_{REF2}, it can be assumed that N₂=N₃, M₂=M₃, N₄=M₄, and N₁=M₁. Equation (4) 374 and Equation (5) 376 are equations for estimating f_{REF1} 328a and f_{REF2} 328b with these assumptions. As illustrated by FIGS. 3B and 3C, f_{IF}_{_{—}}_{RX} 364a, f_{IF}_{_{—}}_{RX} 364b, f_{IF}_{_{—}}_{TX} 362a, f_{IF}_{_{—}}_{TX} 362b, f_{LO}_{_{—}}_{TX} 366a, f_{LO}_{_{—}}_{TX} 366b, f_{LO}_{_{—}}_{RX} 368a, and f_{LO}_{_{—}}_{RX} 368b are known functions of f_{REF1} 328a or f_{REF2} 328b and can be determined based on the value of f_{REF1} 328a or f_{REF2} 328b.

### 3.6 Error Correction

Once IDUs 120 receive a signal from ODUs 110, IDUs 120 can match their frequencies to the frequencies of the received signal from ODUs 110 to enable IDUs 120 to properly receive the signal (e.g., without additional noise or distortion). In an embodiment, error correction module 238a can match f_{IF}_{_{—}}_{TX1} 350a to f_{IF}_{_{—}}_{TX} 362a and/or can match f_{IF}_{_{—}}_{RX1} 352a to f_{IF}_{_{—}}_{RX} 364a. For example, in an embodiment, error correction module can adjust IF digital NCO 306a so that IF digital NCO 306a matches f_{IF}_{_{—}}_{TX1} 350a to f_{IF}_{_{—}}_{TX} 362a and/or matches f_{IF}_{_{—}}_{RX1} 352a to f_{IF}_{_{—}}_{RX} 364a. In an embodiment, error correction module 238a of IDU1 120a then corrects the errors introduced into the received signal.

To cancel IF frequency errors, error correction modules 238 can configure the IF frequencies of IDUs 120 to match the IF frequencies of ODUs 110. This enables error correction modules 238 to cancel the rotation errors R in IDU1 120a and IDU2 120b. For example, as previously discussed, FIG. 2 shows errors that can occur during up-conversion and down-conversion of transmitted data. In FIG. 2, “G” represents gain error between I and Q. “P” represents phase error between I and Q. “R” represents rotation error (e.g., the frequency error between the desired frequency and the actual frequency). As shown in FIG. 2B, up-converter 211, which can be implemented as TX up-converter 302a of IDU1, has a rotation error R₁. Down-converter 212, which can be implemented on TX IF down-converter 316a of ODU1, has a rotation error R₂. Up-converter 234, which can be implemented on RX IF up-converter 320b of ODU2, has a rotation error R₅. Down-converter 237, which can be implemented on RX down-converter 304b of IDU2, has a rotation error R₆. Error correction modules 238 can configure the IF frequencies of IDUs 120 to match the IF frequencies of ODUs 110, as reflected in the following Equations (6) and (7) below:

R₁=R₂⁻¹ (Equation 6)

R₆=R₅⁻¹ (Equation 7)

After cancelling the IF frequency errors, Equation 1 (labeled 262 in FIG. 2B) can be rewritten as Equation 6 below:

$$\begin{matrix}\hat{S} = {G}_{6} {P}_{6} {P}_{5} {G}_{5} {G}_{4} {P}_{4} {R}_{4} {R}_{3} {P}_{3} {G}_{3} {G}_{2} {P}_{2} {P}_{1} {G}_{1} \cdot S = \\ = {G}_{RX} {P}_{RX} {R}_{TX , RX} {P}_{TX} {G}_{TX} \cdot S\end{matrix} \qquad ( Equation 8 )$$

Equation 8 gathers the TX I/Q errors (P_{TX}G_{TX}) and the RX I/Q errors (P_{RX}G_{RX}), where R_{TX,RX} is the frequency error occurring during transmission from IDU1 120a and IDU2 120b, representing the frequency error occurring between the RF signal transmitted by TX RF up-converter 318a and the RF signal received by RX RF down-converter 322a. In Equation 8, the data is represented by S. The data after the effects of TX I/Q mismatch can be represented as P_{TX}G_{TX}·S. The data after the effects of rotation (TX-RX frequency error) can be represented as R_{TX,RX}P_{TX}G_{TX}·S. Finally, the data after the effects of RX I/Q mismatch is shown in Equation 8, i.e., G_{RX}P_{RX}R_{TX,RX}P_{TX}G_{TX}·S. Equation 9 below rewrites Equation 8 to obtain the data S:

S=G_{TX}⁻¹P_{TX}⁻¹R_{TX,RX}⁻¹P_{RX}⁻¹G_{RX}⁻¹Ŝ=G_{TX}⁻¹P_{TX}⁻¹R_{TX,RX}⁻¹P_{RX}⁻¹G_{RX}⁻¹G_{RX}P_{RX}R_{TX,RX}P_{TX}G_{TX}·S (Equation 9)

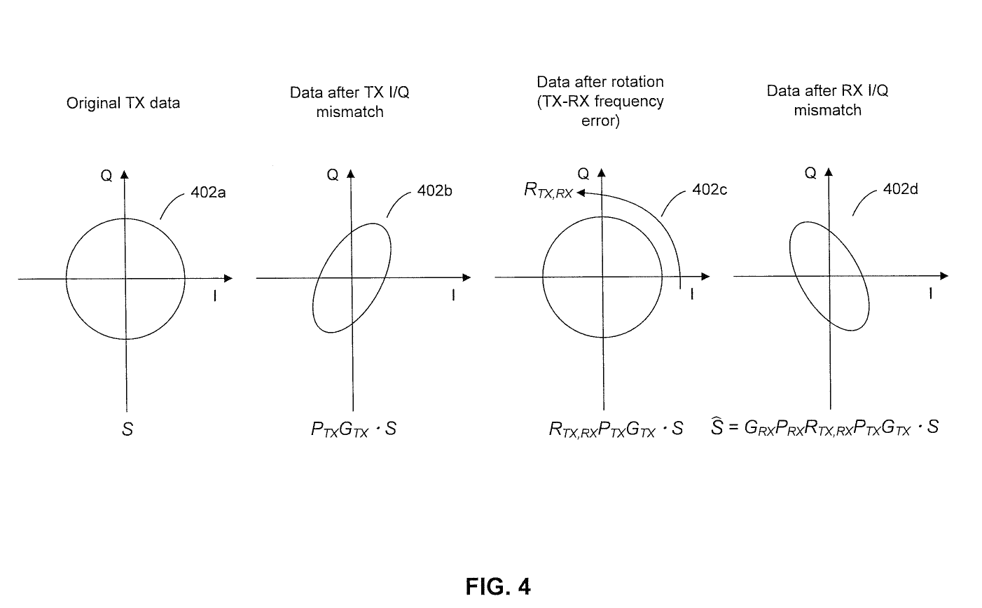

FIG. 4 shows diagrams 402 illustrating I/Q impairments in accordance with an embodiment of the present disclosure. Diagram 402a illustrates an original data signal (labeled “S” in FIG. 4). Diagram 402b illustrates the effects of TX I/Q mismatch (i.e., P_{TX}G_{TX}) on the data signal. Diagram 402c illustrates the effects of TX I/Q mismatch and rotation error (i.e., R_{TX,RX}) on the data signal. Diagram 402d illustrates the effects of TX I/Q mismatch, rotation error, and RX I/Q mismatch (i.e., P_{RX}G_{RX}) on the data signal.

As would be understood by one of skill in the art, using Equations 8 and 9, error correction modules 238 can estimate the I/Q mismatch and frequency errors occurring during communication between IDU1 120a and IDU2 120b. For example, in an embodiment, error correction module 238a can estimate the TX I/Q mismatch to obtain P_{TX}G_{TX} in Equation 8 and can correct the TX I/Q mismatch. Error correction module 238a can estimate the TX-RX frequency error due to rotation to obtain R_{TX,RX} in Equation 8. Error correction module 238a can estimate RX I/Q mismatch to obtain P_{RX}G_{RX} in Equation 8 and can correct the RX I/Q mismatch.

### 3.7 Exemplary Error Correction System

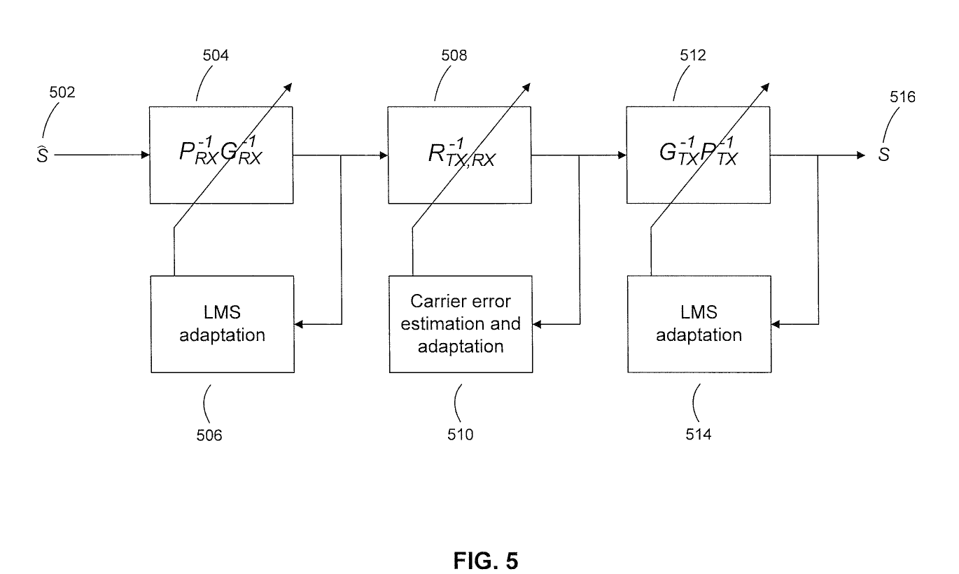

FIG. 5 shows an exemplary estimation and correction system in accordance with an embodiment of the present disclosure. In an embodiment, the estimation and correction system of FIG. 5 can be implemented within either, or both, of error correction modules 238. In FIG. 5, the original data S 516 is recovered from the data modified by impairments Ŝ 502. To estimate and correct the I/Q impairments, error correction modules 238 can use a blind estimation of I/Q mismatch and correction (e.g., an orthogonalization process that can be done on I and Q, which are random uncorrelated signals).

For example, in FIG. 5, least mean square (LMS) adaptation module 506 can use a LMS technique to estimate the values that would correct RX I/Q mismatch (i.e., P_{RX}G_{RX}) 504. Thus, after correction, the signals would be orthogonal. In an embodiment, carrier error estimation and adaptation module 510 can estimate the frequency error between the TX and RX carriers using a PLL that performs carrier error recovery to correct the rotation error (i.e., R_{TX,RX}) 508. In an embodiment, due to the rotation between the transmitter and receiver, error correction modules 238 can distinguish between the I/Q mismatch of the transmitter and receiver. LMS adaptation module 514 can use a LMS technique to correct TX I/Q mismatch (i.e., P_{TX}G_{TX}) 512. After these impairments are corrected, the original data signal S 516 is recovered.

Using these techniques for I/Q mismatch cancellation, embodiments of the present disclosure enable PtP systems, such as PtP microwave backhaul systems, to achieve significant cost and power reduction in the RF section located in ODUs 110. By fixing I/Q impairments of the whole link, the ODU cost and power consumption are lowered. Further, by avoiding having to perform I/Q mismatch cancellation for ODUs 110 in the ODU using RF or digital circuitry, the design cycle for ODUs 110 can be shortened. Additionally, because I/Q mismatch cancellation is performed in IDUs 120, in an embodiment, one side of the link can be working in a split-mount configuration while the other side can be working in an all-ODU (e.g., RF and modem in the ODU) configuration, and the RF section can employ re-modulation in an RX section and superhetrodyne in a TX section (or vice versa).

### 4. METHODS

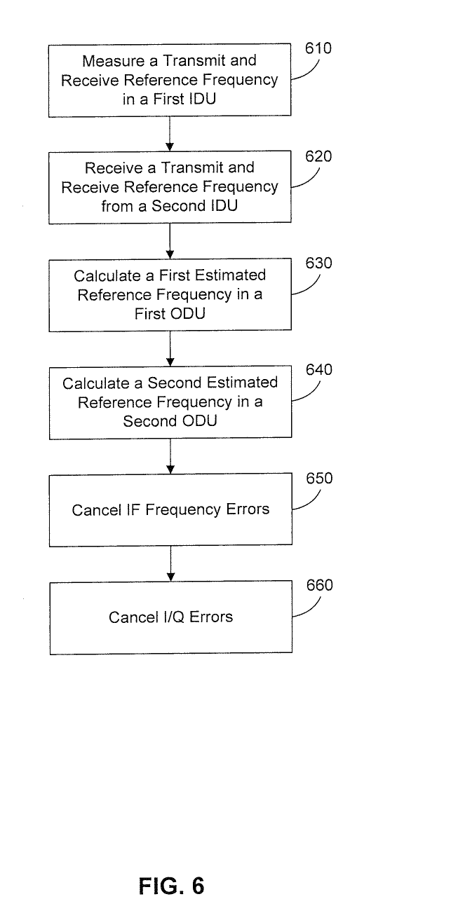

FIG. 6 illustrates a flowchart of a method for correcting impairments in indoor units according to an exemplary embodiment of the present disclosure. In step 610, a signal is received from an ODU. For example, IDU1 120a can receive a signal from ODU1 110a. In step 620, the frequency of the IDU is matched to the frequency of the ODU. For example, error correction module 238a can adjust f_{IF}_{_{—}}_{RX1} provided by IF digital NCO 306a to match the frequency of the received signal.

In step 630, a reference frequency of the ODU is estimated. For example, error correction module 238a can calculate f_{REF1} 328a of ODU1 110a using Equation 2 370. In step 640, impairments occurring during transmission of the signal are cancelled. For example, error correction module 238a can cancel IF frequency errors by setting f_{IF}_{_{—}}_{TX1} 350a of IDU1 120a to be equal to f_{IF}_{_{—}}_{TX} 362a of ODU1 110a and by setting f_{IF}_{_{—}}_{RX1} 352a of IDU1 120a to be equal to f_{IF}_{_{—}}_{RX} 364a of ODU1 110a. Error correction module 238a can further estimate the I/Q mismatch occurring during communication between IDU1 120a and IDU2 120b.

### 5. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g. software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. An indoor unit (IDU), comprising:
an oscillator configured to provide a first signal at a first frequency;
a down-converter configured to receive the first signal and a second signal having a second frequency generated by an outdoor unit (ODU) coupled to the IDU, wherein the down-converter is configured to down-convert the second signal to using the first signal; and
an error correction module coupled to the oscillator and the down-converter, wherein the error correction module is configured to adjust the oscillator, based on a frequency output of the down-converter, so that the first frequency matches the second frequency.

2. The IDU of claim 1, wherein the error correction module is further configured to:
estimate, based on the frequency output of the down-converter, a reference frequency of the ODU.

3. The IDU of claim 2, wherein the error correction module is further configured to:
compensate, based on the reference frequency, for an impairment occurring during communication between the IDU and a second IDU.

4. The IDU of claim 3, wherein the error correction module is further configured to:
cancel an intermediate frequency (IF) error occurring during communication between the IDU and the second IDU to compensate for the impairment.

5. The IDU of claim 3, wherein the error correction module is further configured to:
cancel an in-phase/quadrature (I/Q) error occurring during communication between the IDU and the second IDU to compensate for the impairment.

6. The IDU of claim 5, wherein the error correction module is further configured to:
estimate I/Q mismatch occurring during communication between the IDU and the second IDU to cancel the I/Q error.

7. The IDU of claim 2, wherein the reference frequency is a reference frequency input into a synthesizer of the ODU.

8. The IDU of claim 1, wherein the IDU is implemented in a point to point microwave backhaul system.

9. An error correction module for an indoor unit (IDU), the error correction module comprising:
a first least mean square (LMS) adaptation module configured to correct a receive in-phase/quadrature (I/Q) mismatch for a signal received from an outdoor unit (ODU);
a carrier error estimation and adaptation module configured to correct a rotation error of the signal; and
a second LMS adaptation module configured to correct a transmit in-phase/quadrature (I/Q) mismatch for the signal.

10. The error correction module of claim 9, wherein the error correction module is configured to match a frequency of the IDU to a frequency of the signal.

11. The error correction module of claim 9, wherein the error correction module is implemented on a modem of the IDU.

12. The error correction module of claim 9, wherein the IDU is implemented in a point to point microwave backhaul system.

14. A method for compensating for impairments in an indoor unit (IDU), the method comprising:
receiving, using a processing device, a signal from an outdoor unit (ODU);
matching, using the processing device, a frequency of the IDU to a frequency of the ODU;
estimating, using the processing device, a reference frequency of the ODU; and
compensating, using the processing device, for an impairment in the signal.

15. The method of claim 14, further comprising:
cancelling an intermediate frequency (IF) error occurring during communication between the first IDU and a second IDU to compensate for the impairment.

16. The method of claim 14, further comprising:
cancelling an in-phase/quadrature (I/Q) error in the signal to compensate for the impairment.

17. The method of claim 16, further comprising:
estimating an I/Q mismatch occurring during communication between the IDU and a second IDU to cancel the I/Q error.

18. The method of claim 16, further comprising:
cancelling the I/Q error using a least mean square (LMS) technique.

19. The method of claim 14, further comprising:
cancelling a rotation error in the signal using a carrier error estimation and adaptation technique to compensate for the impairment.

20. The method of claim 14, wherein the reference frequency is a reference frequency input into a synthesizer of the ODU.
